(19) United States
(12) Patent Application Publication
(10) Pub. No.: US 2020/0217211 A1
(43) Pub. Date: Jul. 9, 2020

(54) Method for Optimizing Multi-Stage Components of Large-Scale High-Speed Rotary Equipment Based on Monte Carlo Bias Evaluation

(71) Applicant: Harbin Institute of Technology, Harbin (CN)

(72) Inventors: Chuanzhi SUN, Harbin (CN); Yongmeng LIU, Harbin (CN); Jiubin TAN, Harbin (CN)

(21) Appl. No.: 16/375,172

(22) Filed: Apr. 4, 2019

(30) Foreign Application Priority Data
Jan. 7, 2019 (CN) 201910012269.4

(51) Int. Cl. F01D 5/30

(52) U.S. Cl. CPC F01D 5/30; F05D 2220/323; F05D 2260/81; F05D 2230/60; F05D 2240/24; F05D 2200/20

(57) ABSTRACT

The present invention provides a method for optimizing multi-stage components of large-scale high-speed rotary equipment based on Monte Carlo bias evaluation. The method comprises: obtaining an offset of a contact surface between all stages of rotors according to a multi-stage rotor propagation relationship, and calculating coaxiality according to a coaxiality formula; calculating a cross sectional moment of inertia of the contact surface, and obtaining a bending stiffness according to a bending stiffness formula; obtaining the amount of unbalance of a rotor according to a rotor error propagation relationship; and obtaining a probability relationship between the assembly surface runout of all stages of aero-engine rotors and the final geometric concentricity, the amount of unbalance and stiffness of multi-stage rotors by using a Monte Carlo method, and optimizing the tolerance distribution and bending stiffness of the aero-engine multi-stage rotors.

### TECHNICAL FIELD

The present invention belongs to the technical field of mechanical assembly, and in particular, to a method for optimizing multi-stage components of large-scale high-speed rotary equipment based on Monte Carlo bias evaluation.

### BACKGROUND ART

Multi-stage rotors are a main assembly test object of a core machine of an aero-engine. Under the condition that the component machining accuracy meets requirements, the final inspection is guaranteed by the assembly precision. An engine compressor is formed by stacking multiple stages of rotors. For example, the high-speed rotation speed of a large-scale engine Trent 900 equipped for an A380 aircraft during working is greater than 12,500 rpm. Machine assembly misalignment, excessive amount of unbalance and low machine stiffness will inevitably result in deviation of the center of a turbine disc from the axis of rotation of the engine. Under such conditions, a very large centrifugal force is generated, which causes strong vibration of the engine. Therefore, key points and difficulties of assembly are to ensure multi-stage rotor coaxiality, the amount of unbalance and machine stiffness.

At present, the existing method has the problems that only single-objective optimization of stiffness or coaxiality is performed, unbalanced parameters are not considered, a comprehensive measurement model of stiffness, coaxiality and the amount of unbalance is not established, and the three-objective optimization of combining three parameters namely stiffness, coaxiality and the amount of unbalance cannot be achieved.

### SUMMARY OF THE INVENTION

In order to solve the existing technical problems, the present invention is directed to a method for optimizing multi-stage components of large-scale high-speed rotary equipment based on Monte Carlo bias evaluation. The method of the present invention solves the problem of non-reasonable tolerance distribution of three parameters such as stiffness, coaxiality and the amount of unbalance of an aero-engine rotor, and improves the engine performance.

The present invention is implemented by the following technical solutions. The present invention provides a method for optimizing multi-stage components of large-scale high-speed rotary equipment based on Monte Carlo bias evaluation.

During n rotors assembly, single-stage rotor location and orientation errors are propagated and accumulated to affect an accumulative offset of a single-stage rotor for n rotors assembly, wherein a kth-stage rotor accumulative offset after n-stage rotor assembly may be expressed as:

$$[ \begin{matrix}d {x}_{0 k} \\ d {y}_{0 k}\end{matrix} ] = [ \begin{matrix}1 & 0 & 0 \\ 0 & 1 & 0\end{matrix} ] \cdot {\sum }_{i = 1}^{k} ( {{\prod }_{j = 2}}^{i} {S}_{rj - 1} {S}_{xj - 1} {S}_{yj - 1} ) {S}_{ri} ( {p}_{i} + {dp}_{i} )$$

$$k = 1 , 2 , \text{...} , n ,$$

where dx₀₋ₖ is the accumulative offset of a center of a measurement plane of a kth-stage rotor in an X-axis direction after n-stage rotor assembly, dy₀₋ₖ is the accumulative offset of the center of the measurement plane of the kth-stage rotor in a Y-axis direction after n-stage rotor assembly, pᵢ is the ideal position vector of a center of a radial measurement plane of an ith-stage rotor, dpᵢ is the machining error vector of a center position of the radial measurement plane of the ith-stage rotor, Sᵣᵢ is the rotation matrix of the ith-stage rotor rotating around a Z axis for an angle θᵣᵢ, Sᵣ₁ is unit matrix, Sₓⱼ₋₁ is the rotation matrix of a j-1th-stage rotation stator reference plane rotating around an X axis for an angle θₓⱼ₋₁, S_{yj-1} is the rotation matrix of the j-1th-stage rotation stator reference plane rotating around a Y axis for an angle θ_{yj-1}, and S_{r j-1} is the rotation matrix of the j-1th-stage rotation stator reference plane rotating around a Z axis for an angle θᵣⱼ₋₁.

According to an ISO standard definition of coaxiality, an expression of coaxiality after n-stage rotor assembly is:

coaxiality=max{2\sqrt{dx²₀₋ₖ+dy²₀₋ₖ},k=1,2, . . . ,n}

A cross sectional moment of inertia I of an inter-rotor assembly contact surface after assembly is:

I=π*(R⁴−r⁴)/64−2*∫₀^{de}∫₀^{dθ}π*(R⁴−r⁴)/64dedθ

where R is the outer diameter of the contact surface, r is the inner diameter of the contact surface, the eccentricity is de=/\sqrt{(dx₀₋ₖ)² +(dy₀₋ₖ)²}, the eccentricity angle is dθ=arctan(dy₀₋ₖ/dx₀₋ₖ), and the bending stiffness of a rotor is EI, where E is the elasticity modulus of a material, and a bending stiffness objective function is obtained.

During n rotors assembly, single-stage rotation stator location and orientation errors are propagated and accumulated to affect the amount of unbalance for n rotors assembly, wherein the amount of unbalance of an nth-stage rotor caused by location and orientation errors of all stages of rotors is expressed as:

$$[ \begin{matrix}U {x}_{0 - n} \\ U {y}_{0 - n}\end{matrix} ] = [ \begin{matrix}{m}_{0 - n} & 0 & 0 \\ 0 & {m}_{0 - n} & 0\end{matrix} ] \cdot {\sum }_{i = 1}^{n} ( {{\prod }_{j = 2}}^{i} {S}_{rj - 1} {S}_{xj - 1} {S}_{yj - 1} ) {S}_{ri} ( {p}_{i} + {dp}_{i} )$$

where Ux₀₋ₙ is the amount of unbalance of a measurement plane of an assembled nth-stage rotor in an X-axis direction, Uy₀₋ₙ is the amount of unbalance of the measurement plane of the assembled nth-stage rotor in a Y-axis direction, and m₀₋ₙ is the mass of the assembled nth-stage rotor.

Vector addition is performed on the amount of unbalance of a single-stage rotor and the amount of unbalance introduced by location and orientation errors during the assembly process to obtain the amount of unbalance of any stage of rotor for n rotors assembly, the amounts of unbalance of all stages of rotors are projected to two correction planes respectively, the amount of unbalance is combined according to a dynamic balance formula, and a prediction model for the amount of unbalance of the multi-stage rotors can be established.

According to a Monte Carlo method, 10,000 sets of assembly surface runout data of the multi-stage rotors are generated, a random number is brought into an objective function of multi-stage rotor coaxiality, bending stiffness and the amount of unbalance, a rotation angle of each stage of aero-engine is rotated to obtain 10,000 sets of coaxiality, bending stiffness and the parameters of the amount of unbalance of the multi-stage rotors, a probability density function is solved according to a drawn distribution function to obtain a probability relationship between the assembly surface runout of all stages of aero-engine rotors and the final coaxiality, bending stiffness and the amount of unbalance of the multi-stage rotors, and the tolerance distribution and bending stiffness of the aero-engine multi-stage rotors can be optimized.

### BRIEF DESCRIPTION OF THE DRAWINGS

FIG. 1 is a flowchart of a method for optimizing multi-stage components of large-scale high-speed rotary equipment based on Monte Carlo bias evaluation according to the present invention.

### DETAILED DESCRIPTION OF THE INVENTION

The technical solutions in the examples of the present invention are clearly and completely described in the following with reference to the drawings in the examples of the present invention. It is obvious that the described examples are only a part of the examples of the present invention, and not all of the examples. All other examples obtained by those skilled in the art based on the examples of the present invention without creative efforts are within the scope of protection of the present invention.

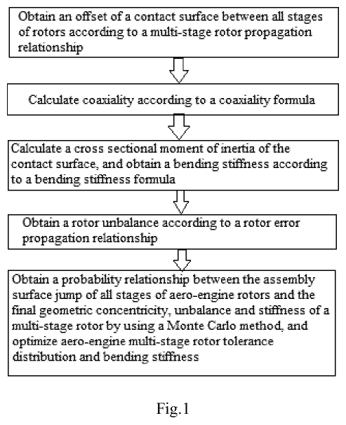

Referring to FIG. 1, the present invention provides a method for optimizing multi-stage components of large-scale high-speed rotary equipment based on Monte Carlo bias evaluation.

During n rotors assembly, single-stage rotor location and orientation errors are propagated and accumulated to affect an accumulative offset of a single-stage rotor for n rotors assembly, wherein a kth-stage rotor accumulative offset after n-stage rotor assembly may be expressed as:

$$[ \begin{matrix}d {x}_{0 k} \\ d {y}_{0 k}\end{matrix} ] = [ \begin{matrix}1 & 0 & 0 \\ 0 & 1 & 0\end{matrix} ] \cdot {\sum }_{i = 1}^{k} ( {{\prod }_{j = 2}}^{i} {S}_{rj - 1} {S}_{xj - 1} {S}_{yj - 1} ) {S}_{ri} ( {p}_{i} + {dp}_{i} )$$

$$k = 1 , 2 , \text{...} , n ,$$

where dx₀₋ₖ is the accumulative offset of a center of a measurement plane of a kth-stage rotor in an X-axis direction after n-stage rotor assembly, dy₀₋ₖ is the accumulative offset of the center of the measurement plane of the kth-stage rotor in a Y-axis direction after n-stage rotor assembly, pᵢ is the ideal position vector of a center of a radial measurement plane of an ith-stage rotor, dpᵢ is the machining error vector of a center position of the radial measurement plane of the ith-stage rotor, Sᵣᵢ is the rotation matrix of the ith-stage rotor rotating around a Z axis for an angle θᵣᵢ, Sᵣ₁ is unit matrix, Sₓⱼ₋₁ is the rotation matrix of a j-1th-stage rotation stator reference plane rotating around an X axis for an angle θₓⱼ₋₁, S_{yj-1} is the rotation matrix of the j-1th-stage rotation stator reference plane rotating around a Y axis for an angle θ_{yj-1}, and S_{r j-1} is the rotation matrix of the j-1th-stage rotation stator reference plane rotating around a Z axis for an angle θᵣⱼ₋₁.

According to an ISO standard definition of coaxiality, an expression of coaxiality after n-stage rotor assembly is:

coaxiality=max{2\sqrt{dx²₀₋ₖ+dy²₀₋ₖ},k=1,2, . . . ,n}

A cross sectional moment of inertia I of an inter-rotor assembly contact surface after assembly is:

I=π*(R⁴−r⁴)/64−2*∫₀^{de}∫₀^{dθ}π*(R⁴−r⁴)/64ded0

where R is the outer diameter of the contact surface, r is the inner diameter of the contact surface, the eccentricity is de=\sqrt{(dx₀₋ₖ)² (dy₀₋ₖ)²}, the eccentricity angle is dθ=arctan(dy₀₋ₖ/dx₀₋ₖ), and the bending stiffness of a rotor is EI, where E is the elasticity modulus of a material, and a bending stiffness objective function is obtained.

During n rotors assembly, single-stage rotation stator location and orientation errors are propagated and accumulated to affect the amount of unbalance for n rotors assembly, wherein the amount of unbalance of an nth-stage rotor caused by location and orientation errors of all stages of rotors is expressed as:

$$[ \begin{matrix}U {x}_{0 - n} \\ U {y}_{0 - n}\end{matrix} ] = [ \begin{matrix}{m}_{0 - n} & 0 & 0 \\ 0 & {m}_{0 - n} & 0\end{matrix} ] \cdot {\sum }_{i = 1}^{n} ( {{\prod }_{j = 2}}^{i} {S}_{rj - 1} {S}_{xj - 1} {S}_{yj - 1} ) {S}_{ri} ( {p}_{i} + {dp}_{i} )$$

where Ux₀₋ₙ is the amount of unbalance of a measurement plane of an assembled nth-stage rotor in an X-axis direction, Uy₀₋ₙ is the amount of unbalance of the measurement plane of the assembled nth-stage rotor in a Y-axis direction, and m₀₋ₙ is the mass of the assembled nth-stage rotor.

Vector addition is performed on the amount of unbalance of a single-stage rotor and the amount of unbalance introduced by location and orientation errors during the assembly process to obtain the amount of unbalance of any stage of rotor for n rotors assembly, unbalances of all stages of rotors are projected to two correction planes respectively, the amount of unbalance is combined according to a dynamic balance formula, and a prediction model for the amount of unbalance of the multi-stage rotors can be established.

According to a Monte Carlo method, 10,000 sets of assembly surface runout data of multi-stage rotors are generated, a random number is brought into an objective function of multi-stage rotor coaxiality, bending stiffness and the amount of unbalance, a rotation angle of each stage of aero-engine is rotated to obtain 10,000 sets of coaxiality, bending stiffness and parameters of the amount of unbalance of the multi-stage rotors, a probability density function is solved according to a drawn distribution function to obtain a probability relationship between the assembly surface runout of all stages of aero-engine rotors and the final coaxiality, bending stiffness and the amount of unbalance of the multi-stage rotors, and the tolerance distribution and bending stiffness of the aero-engine multi-stage rotors can be optimized.

The method of the present invention includes: obtaining an offset of a contact surface between all stages of rotors according to a multi-stage rotor propagation relationship, and calculating coaxiality according to a coaxiality formula; calculating a cross sectional moment of inertia of the contact surface, and obtaining a bending stiffness according to a bending stiffness formula; obtaining the amount of unbalance of a rotor according to a rotor error propagation relationship; and obtaining a probability relationship between the assembly surface runout of all stages of aero-engine rotors and the final geometric concentricity, the amount of unbalance and stiffness of multi-stage rotors by using a Monte Carlo method, and optimizing the tolerance distribution and bending stiffness of the aero-engine multi-stage rotors.

The above is a detailed description of the method for optimizing multi-stage components of large-scale high-speed rotary equipment based on Monte Carlo bias evaluation provided by the present invention. The principle and implementation manner of the present invention are described herein by using specific examples. The foregoing descriptions for the examples are only used to help understand the method of the present invention and its core ideas; at the same time, for those of ordinary skill in the art, according to the idea of the present invention, there will be changes in specific implementation manners and application scopes. To sum up, the description is not to be construed as limiting the present invention.

1. A method for optimizing multi-stage components of a large-scale high-speed rotary equipment based on Monte Carlo bias evaluation, comprising:
during n rotors assembly, single-stage rotor location and orientation errors are propagated and accumulated to affect an accumulative offset of a single-stage rotor for n rotors assembly, wherein a kth-stage rotor accumulative offset after n-stage rotor assembly may be expressed as:
$$[ \begin{matrix}d {x}_{0 k} \\ d {y}_{0 k}\end{matrix} ] = [ \begin{matrix}1 & 0 & 0 \\ 0 & 1 & 0\end{matrix} ] \cdot {\sum }_{i = 1}^{k} ( {{\prod }_{j = 2}}^{i} {S}_{rj - 1} {S}_{xj - 1} {S}_{yj - 1} ) {S}_{ri} ( {p}_{i} + {dp}_{i} )$$
$$k = 1 , 2 , \text{...} , n ,$$
where dx₀₋ₖ is the accumulative offset of a center of a measurement plane of a kth-stage rotor in an X-axis direction after n-stage rotor assembly, dy₀₋ₖ is the accumulative offset of the center of the measurement plane of the kth-stage rotor in a Y-axis direction after n-stage rotor assembly, pᵢ is an ideal position vector of a center of a radial measurement plane of an ith-stage rotor, dpᵢ is a machining error vector of a center position of the radial measurement plane of the ith-stage rotor, Sᵣᵢ is a rotation matrix of the ith-stage rotor rotating around a Z axis for an angle θᵣᵢ, Sᵣ₁ is unit matrix, Sₓⱼ₋₁ is the rotation matrix of a j-1th-stage rotation stator reference plane rotating around an X axis for an angle θₓⱼ₋₁, S_{yj-1} is the rotation matrix of the j-1th-stage rotation stator reference plane rotating around a Y axis for an angle θ_{yj-1}, and S_{r j-1} is the rotation matrix of the j-1th-stage rotation stator reference plane rotating around a Z axis for an angle θᵣⱼ₋₁;
according to an ISO standard definition of coaxiality, an expression of coaxiality after n-stage rotor assembly is:
coaxiality=max{2\sqrt{dx²₀₋ₖ+dy²₀₋ₖ},k=1,2, . . . ,n}
a cross-sectional moment of inertia I of an inter-rotor assembly contact surface after assembly is:
I=π*(R⁴−r⁴)/64−2*∫₀^{de}∫₀^{dθ}π*(R⁴−r⁴)/64dedθ
where R is an outer diameter of the contact surface, r is an inner diameter of the contact surface, the eccentricity is de=\sqrt{(dx₀₋ₖ)² +(dy₀₋ₖ)²}, the eccentricity angle is dθ=arctan(dy₀₋ₖ/dx₀₋ₖ) and the bending stiffness of a rotor is EI, where E is the elasticity modulus of a material, and a bending stiffness objective function is obtained;
during n rotors assembly, single-stage rotation stator location and orientation errors are propagated and accumulated to affect an amount of unbalance for n rotors assembly, wherein the amount of unbalance of an nth-stage rotor caused by location and orientation errors of all stages of rotors is expressed as:
$$[ \begin{matrix}U {x}_{0 - n} \\ U {y}_{0 - n}\end{matrix} ] = [ \begin{matrix}{m}_{0 - n} & 0 & 0 \\ 0 & {m}_{0 - n} & 0\end{matrix} ] \cdot {\sum }_{i = 1}^{n} ( {{\prod }_{j = 2}}^{i} {S}_{rj - 1} {S}_{xj - 1} {S}_{yj - 1} ) {S}_{ri} ( {p}_{i} + {dp}_{i} )$$
where Ux₀₋ₙ is the amount of unbalance of a measurement plane of an assembled nth-stage rotor in an X-axis direction, Uy₀₋ₙ is the amount of unbalance of the measurement plane of the assembled nth-stage rotor in a Y-axis direction, and m₀₋ₙ is the mass of the assembled nth-stage rotor;
performing vector addition on the amount of unbalance of a single-stage rotor and the amount of unbalance introduced by location and orientation errors during an assembly process to obtain the amount of unbalance of any stage of rotor for n rotors assembly, projecting unbalances of all stages of rotors to two correction planes respectively, combining the amount of unbalance according to a dynamic balance formula, and establishing a prediction model for the amount of unbalance of multi-stage rotors; and
generating, according to a Monte Carlo method, 10,000 sets of assembly surface runout data of multi-stage rotors, bringing a random number into an objective function of multi-stage rotor coaxiality, bending stiffness and unbalance, rotating a rotation angle of each stage of aero-engine to obtain 10,000 sets of coaxiality, bending stiffness and parameters of the amount of unbalance of the multi-stage rotors, solving a probability density function according to a drawn distribution function to obtain a probability relationship between the assembly surface runout of all stages of aero-engine rotors and the final coaxiality, bending stiffness and the amount of unbalance of the multi-stage rotors, and optimizing the tolerance distribution and bending stiffness of the aero-engine multi-stage rotors.
